(19) United States
(12) Patent Application Publication
(10) Pub. No.: US 2022/0041895 A1
(43) Pub. Date: Feb. 10, 2022

(54) ADHESIVE TAPE HAVING PERFORATIONS FOR APPLYING TO A RIBBON BEAD NOZZLE

(71) Applicant: Albion Engineering Company, Moorestown, NJ (US)

(72) Inventor: Mark C. SCHNEIDER, Moorestown, NJ (US)

(73) Assignee: Albion Engineering Company, Moorestown, NJ (US)

(21) Appl. No.: 16/984,670

(22) Filed: Aug. 4, 2020

(51) Int. Cl. C09J 7/24; B05B 1/12; C09J 7/40; C09J 7/25

(52) U.S. Cl. CPC C09J 7/241; B05B 1/12; C09J 7/255; C09J 7/405; C09J 7/401

(57) ABSTRACT

An adhesive tape is arranged to be applied over the outlet opening of a nozzle otherwise arranged for dispensing a viscous material as a continuous ribbon bead onto a work surface. The adhesive tape is perforated with a plurality of perforations. By applying the inventive adhesive tape over the outlet opening of the nozzle, the viscous material may be dispensed through the plurality of perforations to form a plurality of continuous filaments on the work surface, rather than a continuous ribbon bead, resulting in waste reduction and greater control over the amount dispensed. Such viscous materials may include construction adhesives, caulking materials, sealants, dual component reactive resins, and the like. The work surface may be the base of a wall to which a length of flexible molding is to be attached by an adhesive.

### BACKGROUND

This invention relates to an adhesive tape having perforations arranged for applying to a ribbon bead nozzle. By adjusting the number and size of perforations in the adhesive tape, the amount of viscous material may be better controlled so that an appropriate amount is dispensed for a particular project.

### SUMMARY

An adhesive tape is arranged to be applied over the outlet opening of a nozzle otherwise arranged for dispensing a viscous material as a continuous ribbon bead onto a work surface. The adhesive tape is perforated with a plurality of perforations. By applying the inventive adhesive tape over the outlet opening of the nozzle, the viscous material may be dispensed through the plurality of perforations to form a plurality of continuous filaments on the work surface, rather than a continuous ribbon bead, resulting in waste reduction and greater control over the amount dispensed. Such viscous materials may include construction adhesives, caulking materials, sealants, dual component reactive resins, and the like. The work surface may be the base of a wall to which a length of flexible molding is to be adhered.

### BRIEF DESCRIPTION OF THE DRAWINGS

The invention will be described in conjunction with the following drawings in which like reference numerals designate like elements and wherein:

FIG. 1 is a perspective view of a ribbon bead nozzle of the prior art attached to a dispensing device and dispensing a viscous material, such as an adhesive, in the form of a continuous ribbon bead;

FIG. 2 is a perspective view of the adhesive tape of the present invention including perforations spaced from each other by a predetermined distance, the adhesive tape shown in a rolled configuration prior to being cut to a predetermined length and applied to the outlet end of a ribbon bead nozzle of the prior art;

FIG. 3 is a plan view of the ribbon bead nozzle of the prior art shown in an untrimmed condition and adjacent to a relatively small segment of the adhesive tape of the present invention;

FIG. 4 is a plan view of the ribbon bead nozzle of the prior art shown trimmed to create a relatively wide opening, the nozzle shown adjacent to a relatively large segment of the adhesive tape of the present invention;

FIG. 5 is a perspective view of the ribbon bead nozzle of the prior art shown in an untrimmed condition with the perforated adhesive tape of the present invention applied to the outlet opening thereof; and,

FIG. 6 is a perspective view of the ribbon bead nozzle of the prior art shown in an untrimmed condition with the perforated adhesive tape of the present invention applied to the opening thereof and dispensing multiple filaments of a flowable material.

### DETAILED DESCRIPTION

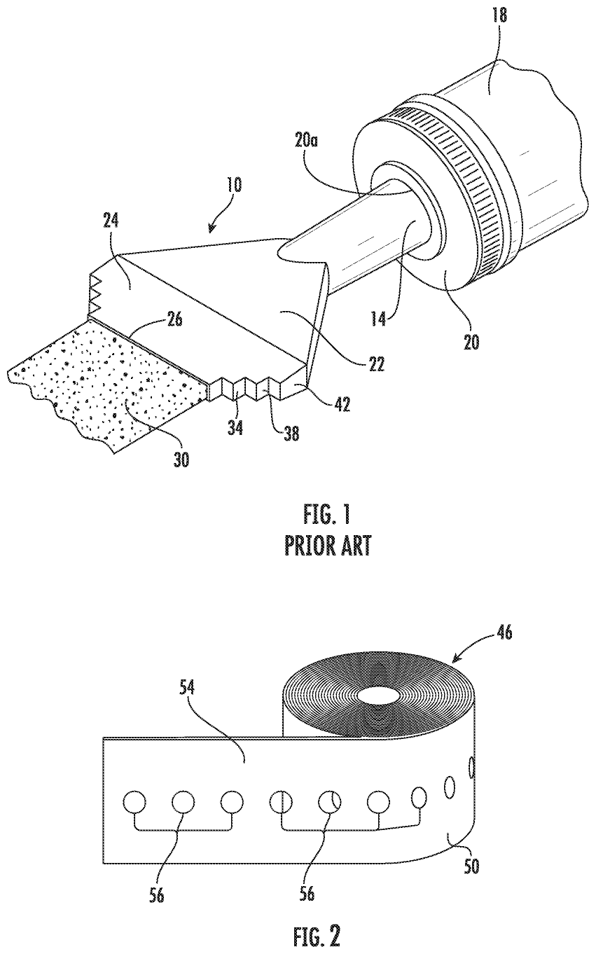

Referring now to FIG. 1, there is shown therein a ribbon bead nozzle 10 of the prior art arranged for dispensing a viscous material in the form of a ribbon bead 30 having a width and a thickness that is determined based upon the dimensions of the outlet opening 26 of the nozzle 10. The prior art ribbon bead nozzle 10 includes a tube-shaped inlet portion 14 arranged to be affixed within the outlet end of a dispensing device 18. The dispensing device 18 may be arranged for dispensing a viscous material, such as an adhesive, in bulk, sausage or cartridge form. The ribbon bead nozzle 10 may be affixed to the dispensing device 18 in any number of ways. For example, the dispensing device 18 may include an internally threaded front cap 20 arranged for screwing onto the externally threaded dispensing end (not shown) of the dispensing device 18. Prior to replacing the front cap 20 onto the barrel of the dispensing device 18, the nozzle 10 is secured to the front cap 20 using a locking plate (not shown). Thereafter, the front cap 20 may be screwed onto the dispensing device 18 to secure the nozzle 10 in place.

In the prior art, during dispensing, viscous material may flow from the dispensing device 18 through the tube-shaped inlet portion 14, through a central body portion 22, through an outlet portion 24 formed of a series of indented recesses 34, 38 and 42, and through an outlet opening 26. From the outlet opening 26, the viscous material 30 emerges in the form of a continuous ribbon bead having a width and thickness predetermined by the width and thickness of the outlet opening 26.

One useful application for the ribbon bead nozzle 10 is the application of an adhesive for installing cove base molding at the base of a wall. As purchased, the outlet opening 26 of the nozzle 10 may include a thickness of ⅛ inches and a width of 2 inches, as shown in FIG. 1. However, the nozzle 10 may be made of any suitable material capable of being cut, e.g., a high quality plastic, and may be provided with a series of indented recesses of increasing width indicated at 34, 38 and 42, which when cut, i.e. using a standard utility knife, will increase the width of the outlet opening 26 to a desired amount depending upon the application. For example, the indented recesses 34, 38 and 42 could be provided in ½ inch increments of increasing width.

By using a utility knife or similar cutting tool, and cutting at a selected indented recess, 34, 38 or 42, the width of the outlet opening 26 may be increased in half-inch increments from 2.0 inches to 4 inches depending upon which indented recess is cut. In this manner, the volume of viscous material dispensed from the outlet opening 26 and the width of the ribbon bead 30 may be controlled based upon the application. However, as the viscous material is still being dispensed as a continuous ribbon, further ability to control the amount dispensed may be desired.

Referring now to FIG. 2, there is shown the perforated adhesive tape 46 of the present invention which provides an added way of controlling the amount of viscous material dispensed from the outlet opening 26 of the ribbon nozzle 10. The adhesive tape 46 includes a base layer 50, an adhesive layer 54 disposed thereover, and a plurality of perforations 56, the size and spacing of which may be adjusted based upon the desired amount of viscous material 30 to be dispensed onto the application area. For example, each perforation 56 may include a diameter of approximately ⅛ inches and be spaced from one another by a predetermined distance of ⅜ inches on centers (from the center of one perforation to the center of the adjacent perforation). The plurality of perforations 56 are preferably uniformly spaced from each other along an entire extent of the perforated adhesive tape 46.

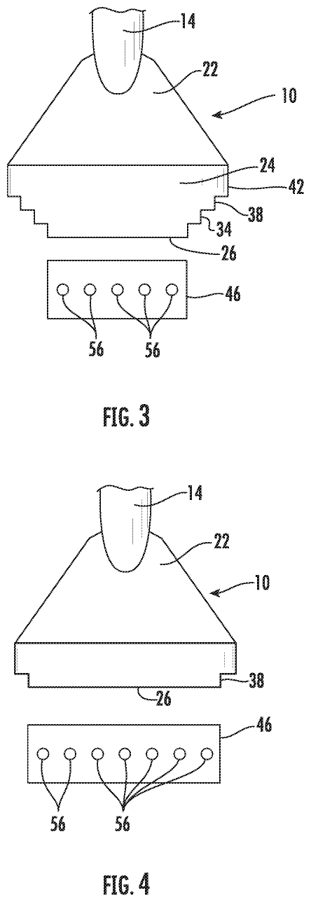

As shown in FIG. 2, the adhesive tape 46 is an elongated strip that may be wound upon itself to form a supply roll which may be payed out to dispense the adhesive tape 46 for cutting in a cross direction to form a strip of a desired length for applying to the outlet opening 26 of the nozzle 10 as shown in FIGS. 3 through 6. Preferably, when cut to length, the strip of adhesive tape 46 is sufficiently long to cover the width of the outlet opening 26. Likewise, the adhesive tape 46 is to be provided in a sufficient width such that when the applied over the outlet opening 26 of the nozzle, it fully covers the outlet end with the remainder to both sides of the outlet opening 26. In this manner, during dispensing, no viscous material will leak around the adhesive tape 46 during dispensing. In one embodiment, the adhesive tape 46 has a thickness of 0.003 inches to 0.004 inches. One of ordinary skill would understand that a thickness of the adhesive tape 46 can vary and is generally selected such that the adhesive tape 46 does not tear during dispensing. As shown in FIGS. 3 and 4, the adhesive tape 46 can be cut to fit any width of the outlet opening 26 of the nozzle 10, including the untrimmed nozzle 10 in FIG. 3, the trimmed nozzle 10 in FIG. 4, or any other size of the outlet opening 26 of the nozzle 10.

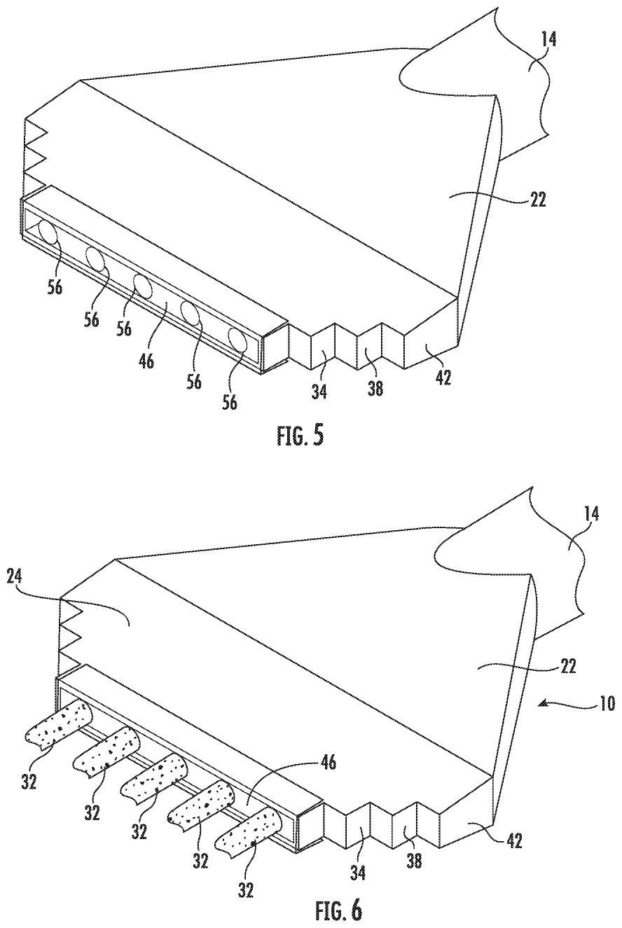

The base layer 50 may be formed of any suitable material, e.g., a polyester film or a polyolefin film, so long as the base layer is capable of being cut in a cross direction. A release liner (not shown) may be detachably disposed onto the adhesive layer 54, and is arranged to be removed prior to applying the adhesive tape to the outlet opening 26. The release liner may be formed of any suitable material, e.g., silicon paper. Once the adhesive tape 46 is applied to the outlet opening 26 of the nozzle 10, the viscous material will be dispensed in the form of multiple filaments 32, rather than as a continuous ribbon bead 30 as shown in the prior art. FIGS. 5 and 6 illustrate the adhesive tape 46 applied to the outlet opening 26 of the nozzle 10. FIG. 6 specifically illustrates multiple filaments 32 being dispensed from the outlet opening 26 of the nozzle 10. By adjusting the spacing and size of the perforations, the size and spacing of the filaments 32, the amount of viscous material can be controlled to assure that an appropriate amount is dispensed for a particular project, and excessive amounts will not need to be troweled off and discarded.

What is claimed is:

1. An adhesive tape arranged for applying over an outlet opening of a ribbon bead nozzle to extrude a plurality of continuous filaments of a viscous material upon a selected work surface, said adhesive tape comprising:
a. a base layer having an elongate length, a width, a first side and a second side, and a thickness;
b. an adhesive layer disposed on said first side to adhere a predetermined length of said adhesive tape over said outlet opening of said ribbon bead nozzle;
c. wherein said adhesive tape is perforated with a plurality of perforations extending the elongate length of said base layer, said plurality of perforations permitting the passage of said viscous material therethrough to form the plurality of continuous filaments on the selected work surface.

2. The adhesive tape of claim 1, wherein said plurality of perforations is spaced apart from one another by a predetermined distance along the length of said base layer.

3. The adhesive tape of claim 1, wherein said plurality of perforations are circular in shape.

4. The adhesive tape of claim 1, additionally comprising a release liner detachably disposed on the surface of said adhesive layer.

5. The adhesive tape of claim 4, wherein said release liner is silicon-coated paper.

6. The adhesive tape of claim 1, wherein said base layer is formed of a material that is cuttable in a cross direction.

7. The adhesive tape of claim 1, wherein said base layer is formed of a polyester film or a polyolefin film.

8. The adhesive tape of claim 6, wherein said adhesive tape may be wound upon itself to form a supply roll which may be payed out to dispense said adhesive tape for cutting to form a strip of a desired length.

9. The adhesive tape of claim 1 having a thickness of 0.003 inches to 0.004 inches.

10. The adhesive tape of claim 8, wherein the outlet opening of the ribbon bead nozzle includes a width and a height, and wherein said strip has a length and a width sufficient to cover the outlet opening of the ribbon bead nozzle.

11. The adhesive tape of claim 10, wherein said adhesive tape strip includes a width that is greater than the height of the outlet opening of the ribbon bead nozzle.

12. The adhesive tape of claim 11, wherein the width of said adhesive tape is approximately three times the height of the outlet opening of the ribbon bead nozzle.

13. The adhesive tape of claim 1, wherein the viscous material is a sealant.

14. The adhesive tape of claim 1, wherein said plurality of perforations each includes a diameter of approximately ⅛″.

15. The adhesive tape of claim 2, wherein said predetermined distance is ⅜″.

16. An applicator assembly for a viscous material, the applicator assembly comprising:
a ribbon bead nozzle defining an outlet opening configured to extrude a viscous material upon a selected work surface; and
an adhesive tape including:
a. a base layer having an elongate length, a width, a first side and a second side, and a thickness;
b. an adhesive layer disposed on said first side and configured to adhere a predetermined length of said adhesive tape over said outlet opening of said ribbon bead nozzle;
said adhesive tape being perforated with a plurality of perforations extending the elongate length of said base layer, said plurality of perforations dimensioned to permit passage of said viscous material therethrough to form a plurality of continuous filaments on the selected work surface.

17. The applicator assembly of claim 16, wherein said ribbon bead nozzle further includes an inlet end adapted for connecting to a hand-held dispensing device.

18. The applicator assembly of claim 16, wherein the ribbon bead nozzle includes a plurality of indented recesses that narrow as they extend from the inlet end to the outlet opening thereof, each indented recess being cuttable to create an outlet opening having a different width, and wherein said adhesive tape is cuttable to form a strip having a length and a width sufficient to cover the outlet opening regardless of which indented recess is cut.

19. The applicator assembly of claim 18, wherein the plurality of indented recesses is left uncut resulting in an outlet opening having a width of approximately 2 inches.

20. The applicator assembly of claim 18, wherein the plurality of indented recesses comprises four indented recesses including a first indented recess that when cut results in an outlet opening having a width of approximately 2½ inches, a second indented recess that when cut results in an outlet opening having a width of approximately 3 inches, a third indented recess that when cut results in outlet opening having a width of approximately 3½ inches, and a fourth indented recess that when cut results in an outlet opening having a width of approximately 4 inches.
